(19) United States
(12) Patent Application Publication
(10) Pub. No.: US 2017/0166184 A1
(43) Pub. Date: Jun. 15, 2017

(54) CONTROL SYSTEM FOR POWER TRANSMISSION SYSTEM

(71) Applicant: TOYOTA JIDOSHA KABUSHIKI KAISHA, Toyota-shi (JP)

(72) Inventors: Takaaki TOKURA, Nagoya-shi (JP); Nobufusa KOBAYASHI, Anjo-shi (JP); Masato YOSHIKAWA, Toyota-shi (JP); Takashi INOUE, Nissin-shi (JP)

(73) Assignee: TOYOTA JIDOSHA KABUSHIKI KAISHA, Toyota-shi (JP)

(21) Appl. No.: 15/366,431

(22) Filed: Dec. 1, 2016

(30) Foreign Application Priority Data
Dec. 10, 2015 (JP) 2015-241634

(51) Int. Cl. B60W 20/13; B60L 11/12; F16H 63/50; B60L 15/20; B60W 10/06; B60W 10/08

(52) U.S. Cl. CPC B60W 20/13; B60W 10/06; B60W 10/08; F16H 63/50; B60L 15/2054; B60L 15/2036; B60L 11/123; B60W 2510/1005; B60W 2510/1095; B60W 2710/0666; B60W 2710/0644; B60K 6/543

(57) ABSTRACT

During an upshift of an mechanical speed change mechanism, electric power generated by a first motor is reduced by a given electric power, from a start point of an inertia phase, such that an absolute value of the first motor torque is reduced, and an AT input rotational speed becomes more likely to be reduced. Thus, the upshift of the mechanical speed change mechanism is made more likely to proceed, and variation of drive torque is suppressed.

### INCORPORATION BY REFERENCE

The disclosure of Japanese Patent Application No. 2015-241634 filed on Dec. 10, 2015 including the specification, drawings and abstract is incorporated herein by reference in its entirety.

### BACKGROUND

1. Technical Field

The disclosure relates to a control system for a power transmission system including an electric speed change mechanism and a mechanical speed change mechanism arranged in series.

2. Description of Related Art

A control system for a power transmission system including an electric speed change mechanism and a mechanical speed change mechanism arranged in series is well known in the art. The electric speed ratio mechanism includes a differential mechanism having three rotating elements, i.e., an input element to which an engine is coupled such that power can be transmitted to the input element, a reaction-force element to which an electric motor for differential operation is coupled such that power can be transmitted to the reaction-force element, and an output element to which an electric motor for travelling of the vehicle is coupled such that power can be transmitted to the output element. The mechanical speed change mechanism is shifted up or down through engagement and release of relevant engagement devices. For example, a control system for a vehicular power transmission system described in Japanese Patent Application Publication No. 2012-240441 (JP 2012-240441 A) is one example of the above type of system. As disclosed in JP 2012-240441A, during an inertia phase of an upshift of the mechanical speed change mechanism, engine torque correction control is performed by increasing engine torque, by an amount corresponding to torque applied to an engine shaft due to change in the rotational speed of an input shaft of the mechanical speed change mechanism caused by the upshift, while keeping a target engine speed.

### SUMMARY

The engine torque correction control described in JP 2012-240441 A is not control for maintaining the target engine speed through torque correction of the motor for differential operation. Therefore, a phenomenon, such as variation of drive torque, does not occur due to reduction of engine directly-reached torque upon completion of torque correction of the motor for differential operation. However, since the input torque to the mechanical speed change mechanism is increased, the shift time is prolonged. On the other hand, if clutch torque of an engagement device that is engaged upon upshift of the mechanical speed change mechanism is increased more quickly, so as to shorten the shift time, variation of the drive torque may become large.

This disclosure provides a control system for use in a power transmission system including an electric speed change mechanism and a mechanical speed change mechanism arranged in series, which control system is able to make an upshift of the mechanical speed change mechanism proceed quickly while suppressing variation in drive torque.

According to one aspect of the disclosure, a control system for a power transmission system is provided. The power transmission system includes an engine, a first motor for differential operation, a second motor for traveling of a vehicle, and an electric speed change mechanism including a differential mechanism. The differential mechanism has three rotating elements, three rotating elements have an input element, a reaction-force element, and an output element, the output element couples to the electric speed change mechanism. An operating state of the first motor is controlled such that a differentially operating state of the differential mechanism is controlled. The input element is coupled to the engine such that power of the engine is transmitted to the input element, and the reaction-force element is coupled to the first motor such that power of the first motor is transmitted to the reaction-force element, while the output element is coupled to the second motor such that power of the second motor is transmitted to the output element. The power transmission system further includes a mechanical speed change mechanism that provides a part of a power transmission path between an output rotating member of the electric speed change mechanism and drive wheels, the mechanical speed change mechanism being adapted to be shifted into a selected one of a plurality of gear positions, through engagement and release of at least one engagement device, and a power storage device that supplies and receives electric power to and from each of the first motor and the second motor. The control system includes an electronic control unit configured to: determine whether an inertia phase has started, during an upshift of the mechanical speed change mechanism; reduce generated electric power of the first motor by a given electric power, from a point in time at which the electronic control unit determines that the inertia phase has started; and control consumed electric power of the second motor based on the generated electric power of the first motor, such that charge/discharge electric power balance of the power storage device remains constant.

According to this disclosure, during the inertia phase of an upshift of the mechanical speed change mechanism, electric power generated by the first motor for differential operation is reduced by the given electric power, from the time when it is determined that the inertia phase has started. Therefore, the absolute value of output torque of the first motor is reduced, such that the rotational speed of an input rotating member of the mechanical speed change mechanism (equivalent to an output rotating member of the electric speed change mechanism) which is reduced upon the upshift of the mechanical speed change mechanism is made more likely to be reduced. In addition, during the inertial phase, electric power consumed by the second motor for traveling of the vehicle is controlled based on the generated electric power of the first motor, such that the charge/discharge electric power balance of the power storage device does not change. Therefore, the output torque of the second motor is reduced, such that the rotational speed of the input rotating member of the mechanical speed change mechanism is made more likely to be reduced toward a post-upshift synchronous rotational speed. Thus, since the upshift of the mechanical speed change mechanism is more likely to proceed, there is no need to increase clutch torque of an engagement device that is engaged upon the upshift more quickly so as to shorten the shift time, and variation in drive torque is suppressed. In the power transmission system including the electric speed change mechanism and the mechanical speed change mechanism arranged in series, when the mechanical speed change mechanism is shifted up, it is possible to make the upshift proceed quickly while suppressing variation in the drive torque.

In the control system according to the above aspect of the disclosure, the electronic control unit may be configured to determine whether a progress of upshift of the mechanical speed change mechanism has reached a given degree of progress, and inhibit control for reducing the generated electric power of the first motor before the upshift ends, when the electronic control unit determines that the progress of the upshift has reached the given degree of progress.

According to this disclosure, after the progress of upshift of the mechanical speed change mechanism reaches the given degree of progress, the control for reducing the generated electric power of the first motor is inhibited before the upshift ends. Therefore, during the inertia phase of upshift of the mechanical speed change mechanism, the control for reducing the generated electric power of the first motor is appropriately performed. Further, after the upshift of the mechanical speed change mechanism ends, the vehicle travels in a condition where the output torque of the first motor and the output torque of the second motor are subject to no restrictions.

In the control system according to the above aspect of the disclosure, the electronic control unit may be configured to control engine torque such that a rotational speed of the engine remains constant, during control performed by the electronic control unit for reducing the generated electric power of the first motor.

According to this disclosure, the engine torque is controlled such that the engine speed does not change during control for reducing the generated electric power of the first motor. Therefore, a variation in the engine speed (a variation in torque applied to the engine shaft) which cannot be completely suppressed through control of the generated electric power of the first motor and control of the consumed electric power of the second motor can be suppressed. While there is a possibility that the engine torque changes during this control, the control is performed so as to absorb its variation that cannot be completely suppressed through control of the first motor and the second motor. Accordingly, variation in engine torque is sufficiently small, as compared with control for positively changing engine torque, like the engine torque correction control under which engine torque is increased by an amount of torque applied to the engine shaft due to upshift. In the upshift of the mechanical shift mechanism while keeping the engine speed constant, the engine speed is unlikely to change during control. If the engine operating point lies on the engine optimum fuel efficiency point before control, it can be kept at the engine optimum fuel efficiency point.

In the control system according to the above aspect of the disclosure, the electronic control unit may be configured to increase the given electric power by which the generated electric power of the first motor is reduced, as a target shift time of upshift of the mechanical speed change mechanism is shorter.

According to this disclosure, the shift time of upshift of the mechanical speed change mechanism can be shortened by increasing the given electric power by which the generated electric power of the first motor is reduced, even without increasing the clutch torque of an engagement device that is engaged upon upshift more quickly. Accordingly, even if the shift time is shortened, variation in the drive torque is suppressed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view schematically showing the configuration of a power transmission system included in a vehicle to which the disclosure is applied, and is also a view useful for explaining control functions and a principal part of a control system for various controls in the vehicle;

FIG. 2 is a nomographic chart showing one example of relative relationships among rotational speeds of respective rotating elements in a power distribution mechanism, when the vehicle is in a hybrid traveling mode;

FIG. 3 is skeleton diagram illustrating one example of an automatic transmission;

FIG. 4 is an operation table explaining the relationship between shift operation of the automatic transmission illustrated in FIG. 3, and a combination of operating states of engagement devices used for shift operation;

FIG. 5 is a flowchart illustrating a principal part of control operation of an electronic control unit, namely, control operation for making upshift of the automatic transmission proceed quickly while suppressing variation in drive torque, in a power transmission system including an electric continuously variable transmission and the automatic transmission arranged in series; and

FIG. 6 is one example of time chart when the control operation illustrated in the flowchart of FIG. 5 is performed.

### DETAILED DESCRIPTION OF EMBODIMENTS

One embodiment will be described in detail with reference to the drawings.

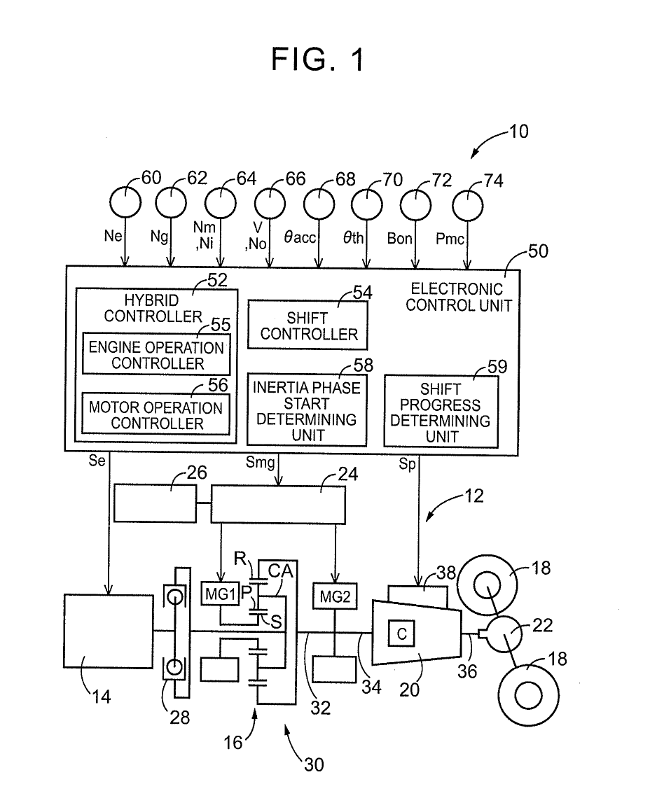

FIG. 1 schematically shows the configuration of a power transmission system 12 provided in a vehicle 10 to which this disclosure is applied, and is also useful for explaining a principal part of a control system for various controls performed in the vehicle 10. In FIG. 1, the vehicle 10 is a hybrid vehicle including an engine 14, a first motor MG1, and a second motor MG2. The power transmission system 12 includes a power distribution mechanism 16, and an automatic transmission (AT) 20 disposed between the power distribution mechanism 16 and drive wheels 18. The power distribution mechanism 16 has a plurality of rotating elements (rotating members) to which the engine 14, first motor MG1, and the second motor MG2 are respectively coupled such that power can be transmitted between the engine 14, first motor MG1, and second motor MG2, and the corresponding rotating elements. In the power transmission system 12, power (which is synonymous with torque or force where they are not particularly distinguished from each other) generated from the engine 14 or the second motor MG2 is transmitted to the automatic transmission 20, and then transmitted from the automatic transmission 20 to the drive wheels 18 via a differential gear unit 22, etc.

The engine 14 is a main power source of the vehicle 10, and is a known internal combustion engine, such as a gasoline engine or a diesel engine. Operating conditions, such as the throttle opening θth or intake air amount, fuel supply amount, and ignition timing, of the engine 14 are controlled by an electronic control unit 50 which will be described later, so that engine torque Te is controlled.

The first motor MG1 and the second motor MG2 are motor-generators having a function as a motor and a function as a generator, and are selectively operated as a motor or a generator. Each of the first motor MG1 and the second motor MG2 is connected to a battery 26 included in the power transmission system 12, via an inverter 24 included in the power transmission system 12. With the inverter 24 controlled by the electronic control unit 50 (which will be described later), MG1 torque Tg and MG2 torque Tm as output torque (or regenerative torque) of each of the first motor MG1 and the second motor MG2 are controlled. The battery 26 is a power storage device that supplies and receives electric power to and from each of the first motor MG1 and the second motor MG2.

The power distribution mechanism 16 is in the form of a known single-pinion-type planetary gear unit having three rotating elements, i.e., a sun gear S, a ring gear R, and a carrier CA, and functions as a differential mechanism that performs differential operation. The ring gear R is disposed concentrically with respect to the sun gear S. The carrier CA supports pinion gears P that mesh with the sun gear S and the ring gear R, such that the pinion gears P can rotate about themselves and rotate about the axis of the gear unit. In the power transmission system 12, the engine 14 is coupled to the carrier CA via a damper 28 such that power can be transmitted between the engine 14 and the carrier CA, and the first motor MG1 is coupled to the sun gear S such that power can be transmitted between the first motor MG1 and the sun gear S, while the second motor MG2 is coupled to the ring gear R such that power can be transmitted between the second motor MG2 and the ring gear R. In the power distribution mechanism 16, the carrier CA functions as an input element, and the sun gear S functions as a reaction-force element, while the ring gear R functions as an output element.

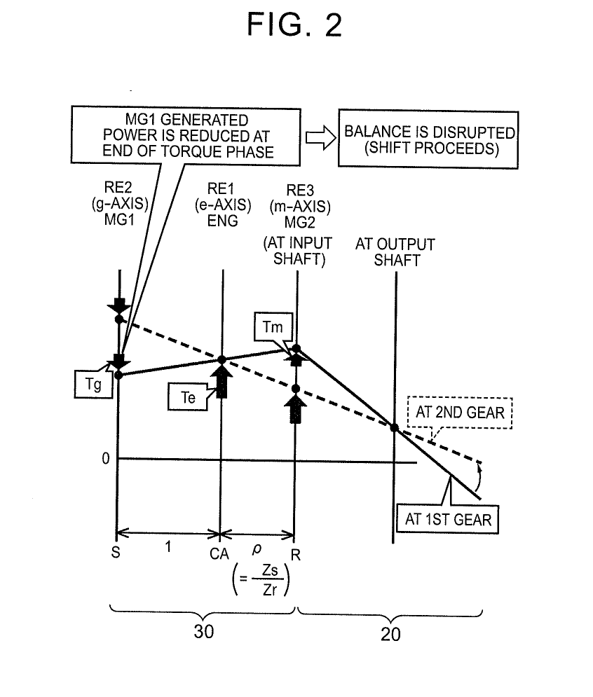

The nomographic chart of FIG. 2 shows relative relationships of the rotational speeds of the respective rotating elements in the power distribution mechanism 16. In the nomographic chart, vertical axis S (g-axis), vertical axis CA (e-axis), and vertical axis R (m-axis) represent the rotational speed of the sun gear S, rotational speed of the carrier CA, and the rotational speed of the ring gear R, respectively. The intervals between the vertical axis S, vertical axis CA, and the vertical axis R are set such that, where the interval between the vertical axis S and the vertical axis CA is 1, the interval between the vertical axis CA and the vertical axis R is equal to p (namely, the gear ratio p of the power distribution mechanism 16=the number of teeth Zs of the sun gear S/the number of teeth Zr of the ring gear R). In FIG. 2, a solid line indicates the relationship of the rotational speeds of the rotating elements when the gear position of the automatic transmission 20 is that of low gear (e.g., first gear position), and a broken line indicates the relationship at the same vehicle speed V and the same engine speed Ne when the gear position of the automatic transmission 20 is that of high gear (e.g., second gear position), for the sake of comparison.

Also, FIG. 2 shows the relative speeds of the respective rotating elements in a hybrid traveling mode in which the vehicle can travel using at least the engine 14 as a drive source. In the hybrid traveling mode, if reaction-force torque as negative torque produced by the first motor MG1 is applied as positive rotation to the sun gear S, against engine torque Te received by the carrier CA, in the power distribution mechanism 16, engine directly-reached torque Td(=Te/(1+ρ)=−(1/ρ)×Tg) that provides positive torque appears as positive rotation on the ring gear R. Then, according to the required driving force, the total or combined torque of the engine directly-reached torque Td and the MG2 torque Tm is transmitted as driving force in the vehicle forward direction to the drive wheels 18 via the automatic transmission 20. At this time, the first motor MG1 functions as a generator that generates negative torque when it is rotated positively. The electric power Wg generated by the first motor MG1 is charged into the battery 26, or consumed by the second motor MG2. The second motor MG2 delivers MG2 torque Tm, using the whole or a part of the generated electric power Wg, or using electric power from the battery 26 in addition to the generated electric power Wg. When electric power Wm consumed by the second motor MG2 is obtained by consuming the whole of the generated electric power Wg, and does not include any electric power from the battery 26, the charge/discharge electric power balance of the battery 26 becomes equal to zero [kW].

Although not illustrated in the drawings, in a nomographic chart for the power distribution mechanism 16 in a motor traveling mode in which the vehicle travels using the second motor MG2 as a drive source with the engine 14 stopped, the carrier CA is not rotated (i.e., rotated at zero speed), and the MG2 torque Tm that provides positive torque is applied as positive rotation to the ring gear R. At this time, the first motor MG1 coupled to the sun gear S is placed in a no-load condition and is rotated at idle in negative direction. Namely, in the motor traveling mode, the engine 14 is not driven, and the engine speed Ne is equal to zero, while the MG2 torque Tm (here, power running torque of positive rotation) is transmitted as driving force in vehicle forward direction to the drive wheels 18 via the automatic transmission 20.

The power transmission system 12 includes the power distribution mechanism 16 having three rotating elements, i.e., the carrier CA as a first rotating element RE1 to which the engine 14 is operatively coupled, the sun gear S as a second rotating element RE2 to which the first motor MG1 as an electric motor for differential operation is operatively coupled, and the ring gear R as a third rotating element RE3 to which the second motor MG2 as a motor for running the vehicle is operatively coupled. Thus, in the power transmission system 12, an electric continuously variable transmission 30 (see FIG. 1) as an electric speed change mechanism (electric differential mechanism) is constructed in which an operating state of the first motor MG1 is controlled so that a differential status of the power distribution mechanism 16 is controlled. Namely, the electric continuously variable transmission 30 has the power distribution mechanism 16 operatively coupled to the engine 14, and the first motor MG1 operatively coupled to the power distribution mechanism 16, and the operating state of the first motor MG1 is controlled so that a differential status of the power distribution mechanism 16 is controlled. The electric continuously variable transmission 30 is operable to change the speed ratio γ0(=engine speed Ne/MG2 rotational speed Nm).

Referring back to FIG. 1, the automatic transmission 20 is a mechanical speed change mechanism that provides a part of a power transmission path between a transmission member 32 as an output rotating member of the electric continuously variable transmission 30, and the drive wheels 18. The transmission member 32 is coupled integrally with the ring gear R, and is also coupled integrally with a transmission input shaft (AT input shaft) 34 as an input rotating member of the automatic transmission 20. The power transmission system 12 includes the electric continuously variable transmission 30 and the automatic transmission 20 arranged in series. The automatic transmission 20 is a known planetary gear type automatic transmission that has two or more planetary gear units and two or more engagement devices, for example. The automatic transmission 20 performs so-called clutch-to-clutch shifting by engaging and releasing selected ones of the two or more engagement devices (namely, by switching engaged and released states of the engagement devices). Namely, the automatic transmission 20 is a mechanical speed change mechanism that changes the speed ratio through engagement and release of the engagement devices, so as to form a selected one of two or more gear positions having difference speed ratios (gear ratios) γat(=AT input rotational speed Ni/AT output rotational speed No).

The above-mentioned two or more engagement devices are hydraulic friction devices that transmit rotation and torque between the transmission input shaft 34 that receives power from the engine 14 and the second motor MG2, and a transmission output shaft (AT output shaft) 36 as an output rotating member of the automatic transmission 20 that transmits power to the drive wheels 18. The torque capacity (clutch torque) of each of the engagement devices is changed by regulating the engaging hydraulic pressure (clutch pressure) by means of a solenoid valve, or the like, in a hydraulic control circuit 38 included in the automatic transmission 20, so that engagement and release of the engagement device are controlled. In this embodiment, the two or more engagement devices will be called “clutches C”, for the sake of convenience, but the clutches C include known brakes, etc., as well as clutches.

In this connection, the clutch torque of each clutch C is determined by the friction coefficient of a friction material of the clutch C, and the clutch hydraulic pressure with which friction plates are pressed, for example. In order to transmit torque (for example, AT input torque Ti as torque applied to the transmission input shaft 34) between the transmission input shaft 34 and the transmission output shaft 36 without slipping the clutch C (namely, without producing a difference in the rotational speed of the clutch C), clutch torque is needed which provides a clutch transmission torque portion (namely, torque allocated to each clutch C) as a part of the clutch torque which needs to be provided by each of the clutches C. It is, however, to be noted that, even if the clutch torque that provides the clutch transmission torque portion for each clutch C is increased, the clutch transmission torque is not increased. Namely, the clutch torque corresponds to the maximum torque that can be transmitted via the clutches C, and the clutch transmission torque corresponds to torque actually transmitted via the clutches C. The clutch torque (or clutch transmission torque) and the clutch hydraulic pressure have a generally proportional relationship, except for a region in which the clutch hydraulic pressure needed for eliminating clearances in a pack of the clutch C is supplied (namely, a condition where the friction material and friction plates of the clutch C are in abutting contact with each other, and the clutch torque capacity arises if the clutch hydraulic pressure is further raised).

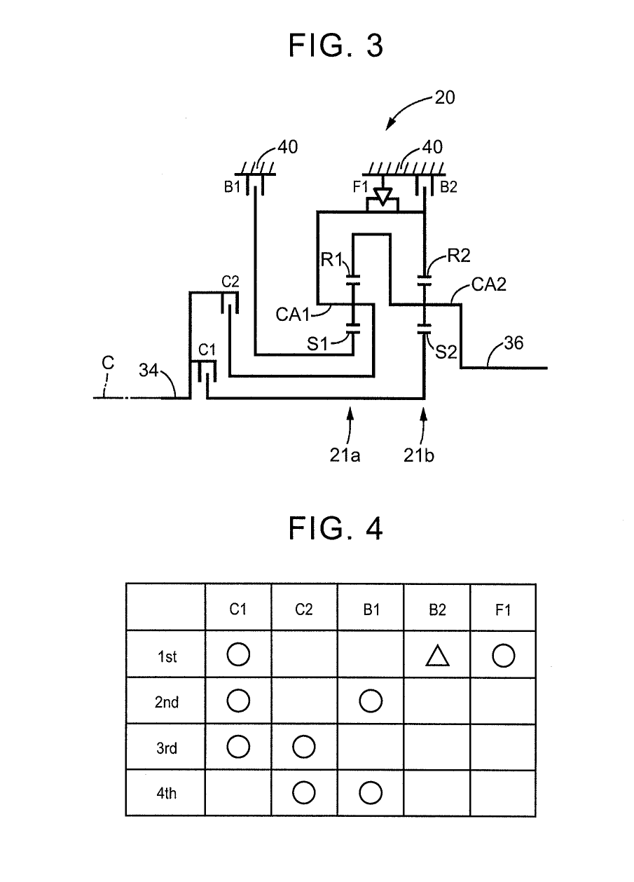

FIG. 3 is a skeleton diagram that illustrates one example of the automatic transmission 20. The automatic transmission 20 is constructed generally symmetrically with respect to the axis C of the transmission input shaft 34, and the lower half of the automatic transmission 20 below the axis C is not illustrated in FIG. 3. In FIG. 3, the automatic transmission 20 includes a first planetary gear unit 21a and a second planetary gear unit 21b having rotating elements (sun gears S1, S2, carriers CA1, CA2, and ring gears R1, R2). Each of the rotating elements of the first and second planetary gear units 21a, 21b is coupled to another rotating element, or coupled to the transmission input shaft 34, a case 40 as a non-rotating member, or the transmission output shaft 36, directly or indirectly (or selectively) via a clutch C (clutch C1, C2, or brake B1, B2) or a one-way clutch F1. The automatic transmission 20 is placed in a selected one of four forward gear positions, as indicated in an engagement operation table of FIG. 4, according to the accelerating operation of the driver, the vehicle speed V, etc., through engagement/release control of each of the clutches C. In FIG. 4, “1st” through “4th” indicate first gear position through fourth gear position as forward gear positions. The engagement operation table of FIG. 4 shows the relationship between each of the above-indicated gear positions and respective operating states of the clutches C. In FIG. 4, “O” indicates engaged state, and “Δ” indicates engaged state when engine brake is applied, while blank indicates released state. Since the one-way clutch F1 is provided in parallel with the brake B2 that establishes first gear position “1st”, there is no need to engage the brake B2 when the vehicle is started (or accelerated).

Referring back to FIG. 1, the vehicle 10 has the electronic control unit 50 including a control system of the power transmission system 12, for example. FIG. 1 shows an input/output system of the electronic control unit 50, and is also a functional block diagram useful for explaining a principal part of control functions performed by the electronic control unit 50. The electronic control unit 50 includes a so-called microcomputer having CPU, RAM, ROM, input/output interface, etc., and performs various controls of the vehicle 10, by conducting signal processing according to programs stored in advance in the ROM, while utilizing the temporary storage function of the RAM. For example, the electronic control unit 50 performs output control of the engine 14, output control, including regeneration control, each of the first motor MG1 and the second motor MG2, shift control of the automatic transmission 20, and so forth, and is configured to be divided into sub-units for engine control, motor control, hydraulic control (shift control), etc., as needed.

The electronic control unit 50 is supplied with various actual values based on detection signals detected by various sensors included in the vehicle 10. The sensors include, for example, an engine speed sensor 60, motor speed sensors 62, 64, such as resolvers, vehicle speed sensor 66, accelerator pedal position sensor 68, throttle opening sensor 70, brake switch 72, and a master cylinder pressure sensor 74. The above-mentioned actual values include, for example, an engine speed Ne as the rotational speed of the engine 14, MG1 rotational speed Ng as the rotational speed of the first motor MG1, MG2 rotational speed Nm as the rotational speed of the second motor MG2 corresponding to an AT input rotational speed Ni as the rotational speed of the transmission input shaft 34, AT output rotational speed No as the rotational speed of the transmission output shaft 36 corresponding to the vehicle speed V, accelerator pedal stroke θacc as the operation amount of the accelerator pedal representing the amount of acceleration requested by the driver, throttle opening θth as the opening of an electronic throttle valve, brake-on Bon as a signal indicating a condition (brake operated condition) in which a braking operation (e.g., brake pedal operation) to apply wheel brakes as service brakes is performed, and a brake fluid pressure (master cylinder pressure) Pmc generated from a brake master cylinder and corresponding to a brake hydraulic pressure (braking pressure) supplied to the wheel cylinders according to the braking operation performed by the driver. Also, the electronic control unit 50 generates an engine output control command signal Se for output control of the engine 14, motor control command signal Smg for operating the inverter 24 that controls the first motor MG1 and the second motor MG2, hydraulic control command signal Sp for controlling the clutch(es) C associated with shifting of the automatic transmission 20, and so forth. The hydraulic control command signal Sp is, for example, a command signal (hydraulic command value) for driving each solenoid valve that regulates each clutch pressure supplied to a hydraulic actuators of each of the clutches C. The hydraulic control command signal Sp is generated to the hydraulic control circuit 38.

The electronic control unit 50 includes a hybrid control means or hybrid controller 52, and a shift control means or shift controller 54.

The hybrid controller 52 has a function as an engine operation control means or engine operation controller 55 for controlling operation of the engine 14, and a function as a motor operation control means or motor operation controller 56 for controlling operation of the first motor MG1 and the second motor MG2 via the inverter 24. The hybrid controller 52 uses these control functions to perform hybrid drive control, etc. on the engine 14, first motor MG1, and the second motor MG2. More specifically, the hybrid controller 52 calculates the required driving force Fdem by applying the accelerator pedal stroke θacc and the vehicle speed V to a predetermined relationship (e.g, driving force map) that is empirically or theoretically obtained and stored in advance. The hybrid controller 52 outputs command signals (engine output control command signal Se and motor control command signal Smg) for controlling the engine 14, first motor MG1, and the second motor MG2, so as to obtain the required driving force Fdem, in view of the engine optimum fuel efficiency point, transmission loss, accessory load, gear ratio γat of the automatic transmission 20, chargeable/dischargeable electric power Win, Wout of the battery 26, and so forth. As a result of the control, the speed ratio γ0 of the electric continuously variable transmission 30 is controlled.

The shift controller 54 performs shift control of the automatic transmission 20, in coordination with control of the engine 14, first motor MG1, second motor MG2, and the speed ratio γ0 of the electric continuously variable transmission 30, performed by the hybrid controller 52, so as to obtain the required driving force Fdem. More specifically, when the shift controller 54 determines that the automatic transmission 20 should be shifted up or down to a certain gear position, it outputs a hydraulic control command signal Sp for engaging and/or releasing the clutch(es) C associated with shifting of the automatic transmission 20, to the hydraulic control circuit 38, so as to form the gear position thus determined.

In the meantime, when upshift of the automatic transmission 20 is performed, torque is applied to the carrier CA (e axis) to which the engine 14 is coupled, in such a direction as to reduce its rotational speed, due to reduction of the rotational speed of the transmission input shaft 34 (see FIG. 2). In this situation, it may be considered to execute engine torque correction control for increasing engine torque Te, so as to maintain a target engine speed, during an inertia phase in the upshift of the automatic transmission 20. However, since the engine torque is increased, the engine optimum fuel efficiency point may not be maintained, and the fuel efficiency or economy may deteriorate. On one hand, it may be considered to maintain the target engine speed, by executing MG1 torque correction control for reducing the absolute value of the MG1 torque Tg. However, when the charge/discharge electric power balance of the battery 26 is restricted, the MG1 torque correction control may not be appropriately performed. Therefore, the engine optimum fuel efficiency point may not be maintained, simply by performing the MG1 torque correction control. On the other hand, in the upshift of the automatic transmission 20, clutch torque (which will be called “engaging clutch torque Tce”) of a clutch C that is to be engaged upon upshifting is increased, so as to make the upshift proceed. Therefore, as the engaging clutch torque Tce is increased more quickly or at a higher rate in an attempt to shorten the shift time, the AT output torque To as torque generated from the transmission output shaft 36 rises or increases, and variation of drive torque may become large during upshifting of the automatic transmission 20. The engaging clutch torque Tce is clutch torque Tb1 of the brake B1, in a 1st to 2nd-speed upshift in the configuration of the automatic transmission 20 illustrated in FIG. 3.

Thus, the electronic control unit 50 performs control for reducing electric power Wg generated by the first motor MG1 at an end point of the torque phase (i.e., at a start point of the inertia phase), during upshifting of the automatic transmission 20. Since the MG1 rotational speed Ng undergoes almost no change at the start point of the inertia phase, reduction of the generated electric power Wg means reduction of the absolute value of the MG1 torque Tg (negative value). As the MG1 torque Tg is reduced, the MG1 rotational speed Ng is more likely to increase, and the balance in the relative relationships of the rotational speeds of the three rotating elements in the power distribution mechanism 16 is disrupted. As a result, the MG2 rotational speed Nm becomes more likely to be reduced (namely, the AT input rotational speed Ni becomes more likely to be reduced), and the upshift of the automatic transmission 20 becomes more likely to proceed even if the engaging clutch torque Tce is not increased at a higher rate. Accordingly, the electronic control unit 50 keeps the generated electric power Wg reduced, during the inertia phase. Also, the electronic control unit 50 performs control for reducing electric power Wm consumed by the second motor MG2, by an amount corresponding to reduction of the generated electric power Wg. This prevents the charge/discharge electric power balance of the battery 26 from being changed, and this control can be carried out even when the charge/discharge electric power balance of the battery 26 is restricted. Since the MG2 rotational speed Nm undergoes almost no changes at the start point of the inertia phase, reduction of the consumed electric power Wm means reduction of the absolute value of the MG2 torque Tm (positive value). More simply, the MG2 torque Tm is reduced. As the MG2 torque Tm is reduced, the MG2 rotational speed Nm becomes more likely to be reduced, and the upshift of the automatic transmission 20 becomes more likely to proceed.

After the upshift of the automatic transmission 20 ends, it is desirable to return to an original state in which the generated electric power Wg of the first motor MG1 is not reduced. Thus, the electronic control unit 50 starts returning to the original state in which the generated electric power Wg of the first motor MG1 is not reduced, when the upshift of the automatic transmission 20 proceeds to a given extent, and the original state is resumed by the time when the upshift of the automatic transmission 20 ends.

The control for reducing the generated electric power Wg of the first motor MG1, and control for reducing the consumed electric power Wm of the second motor MG2, are performed so as to keep the engine speed Ne as it is without changing the engine torque Te, during the inertia phase of upshift of the automatic transmission 20. However, actually, the engine speed Ne may vary. Thus, the electronic control unit 50 suppresses or reduces variation in the engine speed Ne, by controlling the engine torque Te. While the engine torque Te may vary under the control of the engine torque Te, the control is only required to suppress a variation in the engine speed Ne which cannot be completely suppressed through control of the motors. Thus, the above control is not intended to positively change the engine torque Te, like the above-described engine torque correction control; therefore, variation in the engine torque Te is made sufficiently small, as compared with that under the engine torque correction control.

As the generated electric power Wg of the first motor MG1 is reduced, upshift of the automatic transmission 20 becomes more likely to proceed, and the shift time of the upshift can be shortened. Thus, the electronic control unit 50 determines the generated electric power Wg of the first motor MG1, based on a target shift time of upshift of the automatic transmission 20.

More specifically, the electronic control unit 50 further includes an inertia phase start determining means or inertia phase start determining unit 58, and a shift progress determining means or shift progress determining unit 59.

The inertia phase start determining unit 58 determines whether the inertia phase has started, during upshifting of the automatic transmission 20. The inertia phase start determining unit 58 calculates a pre-shift synchronous AT input rotational speed Nisb(=No×γatb) as the synchronous rotational speed of the transmission input shaft 34 before shift, based on the AT output rotational speed No and the pre-shift gear ratio γatb of the automatic transmission 20, during upshifting of the automatic transmission 20. The inertia phase start determining unit 58 determines whether the inertia phase has started, based on whether a differential rotational speed ΔNib(=Nisb−Ni) between the pre-shift synchronous AT input rotational speed Nisb and the AT input rotational speed Ni becomes equal to or larger than a predetermined threshold value based on which start of the inertia phase is determined.

In the inertia phase during upshifting of the automatic transmission 20, the motor operation controller 56 reduces the generated electric power Wg of the first motor MG1 by a given electric power, from the time when the inertia phase start determining unit 58 determines that the inertia phase has started, so that the generated electric power Wg becomes smaller than that detected when it is determined that the inertia phase has started. The motor operation controller 56 reduces the generated electric power Wg of the first motor MG1 by the given electric power, by reducing the MG1 torque Tg by a given torque over a given period of time, and then keeps the generated electric power Wg reduced by the given electric power, by controlling the MG1 torque Tg. The given electric power, the given torque, and the given period of time are determined in advance for each type of shift, such as a 1st to 2nd-speed upshift or a 2nd to 3rd-speed upshift, so that the engine speed Ne can be kept constant during upshifting of the automatic transmission 20, for example. While a fixed value determined in advance for each type of shift may be used as the given electric power, the given electric power may also be determined based on the target shift time of upshift of the automatic transmission 20. Namely, the motor operation controller 56 increases the given electric power used when the generated electric power Wg of the first motor MG1 is reduced, as the target shift time of upshift of the automatic transmission 20 is shorter. This manner of control is useful when the target shift time of upshift of the automatic transmission 20 is changed according to a traveling condition, such as whether the accelerator pedal is depressed or released, for example.

In the inertial phase during upshifting of the automatic transmission 20, the motor operation controller 56 controls the consumed electric power Wm of the second motor MG2, based on the generated electric power Wg of the first motor MG1, so that the charge/discharge electric power balance of the battery 26 does not change. The motor operation controller 56 reduces the consumed electric power Wm of the second motor MG2 by reducing the MG2 torque Tm, so that the given power used when the generated power Wg of the first motor MG1 is reduced coincides with electric power by which the consumed electric power Wm is reduced. Then, the MG2 torque Tm is controlled so that the consumed electric power Wm is kept reduced. When the second motor MG2 generates the MG2 torque Tm using the whole of the generated electric power Wg, without using electric power taken out of the battery 26, such that the vehicle travels with the charge/discharge power balance being equal to zero, the motor operation controller 56 controls the MG2 torque Tm, so as to keep the charge/discharge electric power balance of the battery 26 equal to zero. In this case, the motor operation controller 56 controls the second motor MG2 to provide the MG2 torque Tm calculated based on the following equation (1).

Tm=Ng/Nm×Tg (1)

The shift progress determining unit 59 determines whether the progress of upshift of the automatic transmission 20 has reached a given degree of progress. The given degree of progress is a criterial threshold value that is determined in advance as a degree or stage of progress where the effect yielded by reducing the generated electric power Wg of the first motor MG1 is sufficiently obtained, and the automatic transmission 20 can return to the original state in which the generated electric power Wg of the first motor MG1 is not reduced, before the end of the upshift. More specifically, in the initial phase during upshifting of the automatic transmission 20, the shift progress determining unit 59 calculates a post-shift synchronous AT input rotational speed Nisa(=No×γata) as the synchronous rotational speed of the transmission input shaft 34 after shift, based on the AT output rotational speed No and the post-shift gear ratio γata of the automatic transmission 20. The shift progress determining unit 59 calculates a synchronization predicted time it takes until the AT input rotational speed Ni reaches the post-shift synchronous AT input rotational speed Nisa, based on the AT input rotational speed Ni and the rate of change dNi/dt of the AT input rotational speed Ni. Then, the shift progress determining unit 59 determines whether the progress of upshift of the automatic transmission 20 has reached the given degree of progress, during the inertia phase, based on whether a differential rotational speed ΔNia(=Ni−Nisa), or a difference between the AT input rotational speed Ni and the post-shift synchronous AT input rotational speed Nisa, is equal to or smaller than a given differential speed that is determined in advance for determining the progress of upshift.

When the shift progress determining unit 59 determines that the progress of upshift of the automatic transmission 20 has reached the given degree of progress, the motor operation controller 56 cancels control for reducing the generated electric power Wg of the first motor MG1, by the time when the upshift of the automatic transmission 20 ends. When the progress of upshift of the automatic transmission 20 has reached the given degree of progress, the motor operation controller 56 starts returning to the state in which the generated electric power Wg of the first motor MG1 is not reduced, by reducing the amount of reduction of the generated electric power Wg of the first motor MG1. Then, before the upshift of the automatic transmission 20 ends, the motor operation controller 56 completely finishes control for reducing the generated electric power Wg, and returns to the state in which the generated electric power Wg is not reduced, by the time when the upshift of the automatic transmission 20 ends. In accordance with the start of return to the state in which the generated electric power Wg is not reduced, the motor operation controller 56 reduces the amount of reduction of the consumed electric power Wm of the second motor MG2, and starts returning to the state in which the consumed electric power Wm is not reduced. Then, the motor operation controller 56 completely finishes the control for reducing the consumed electric power Wm, and returns to the state in which the consumed electric power Wm is not reduced, before the upshift of the automatic transmission 20 ends.

The engine operation controller 55 controls engine torque Te so as not to change the engine speed Ne, during control for reducing the generated electric power Wg of the first motor MG1 by the motor operation controller 56. The engine operation controller 55 calculates engine torque Te that makes the rate of change dNe/dt of the engine speed Ne equal to zero, in the following equation (2), and controls the engine 14 so as to provide the engine torque Te. The following equation (2) is a given relational expression for calculating the rate of change dNe/dt of the engine speed Ne, based on wheel brake torque Tbr applied to the transmission output shaft 36, engine torque Te, MG1 torque Tg, MG2 torque Tm, and engaging clutch torque Tce. In the following equation (2), a, b, c, d, e are constants derived based on respective motion equations of the electric continuously variable transmission 30 and the automatic transmission 20. The wheel brake torque Tbr is calculated based on the master cylinder pressure Pmc, for example.

dNe/dt=a×Tbr+b×Te+c×Tm+d×Tg+e×Tce (2)

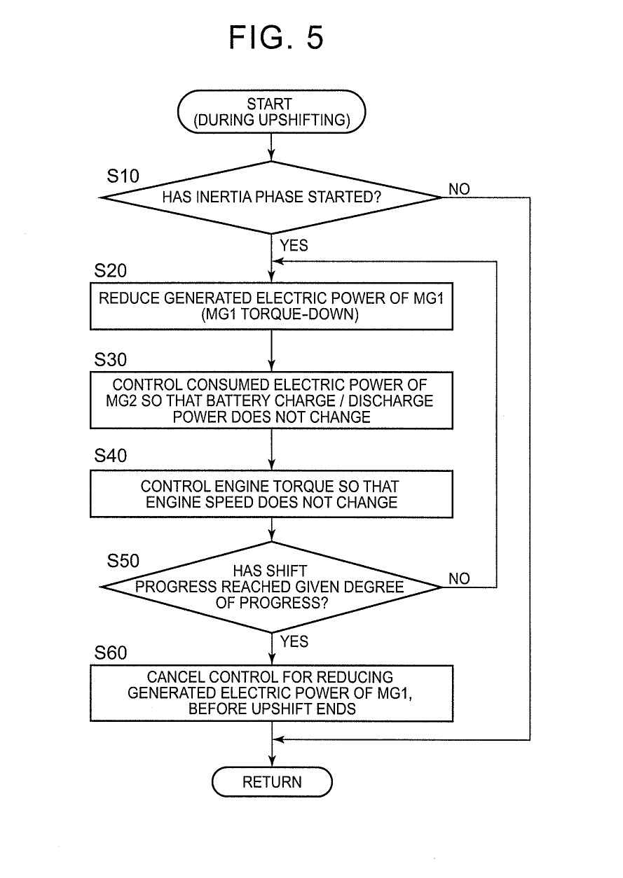

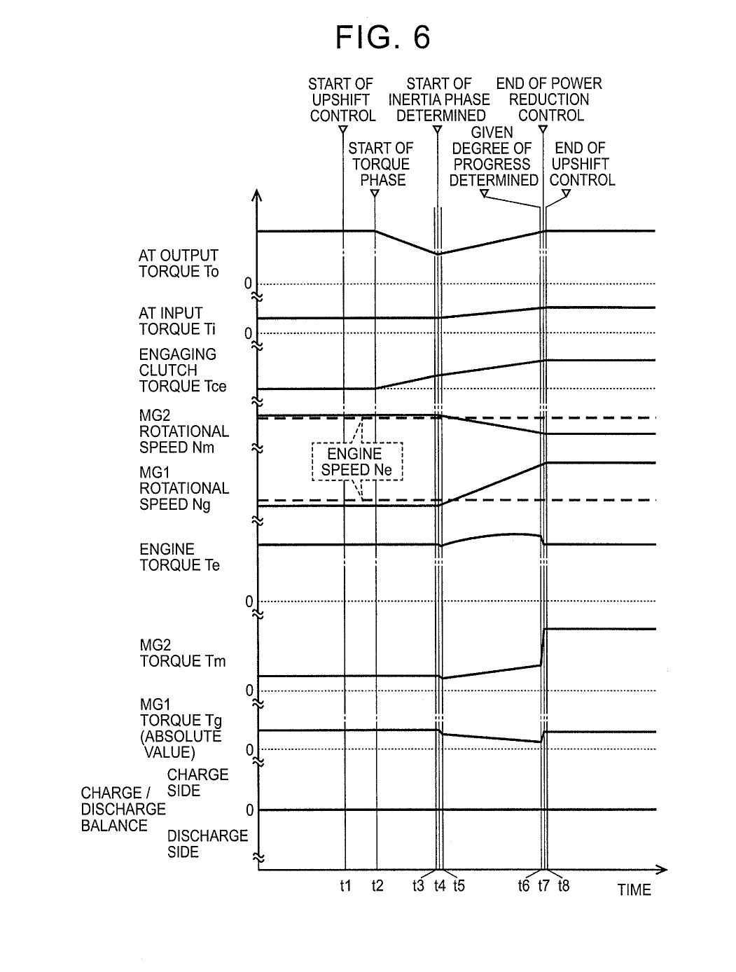

FIG. 5 is a flowchart useful for explaining a principal part of control operation of the electronic control unit 50, namely, control operation for quickly progressing upshift of the automatic transmission 20 while suppressing variation in drive torque, in the power transmission system 12 including the electric continuously variable transmission 30 and the automatic transmission 20 arranged in series. The control routine of FIG. 5 is repeatedly executed during upshifting of the automatic transmission 20. FIG. 6 is one example of time chart when the control operation illustrated in the flowchart of FIG. 5 is performed.

In FIG. 5, it is determined in step S10 corresponding to a function of the inertia phase start determining unit 58 whether the inertia phase has started. If a negative decision (NO) is made in step S10, this routine is finished. If an affirmative decision (YES) is made in step S10, the generated electric power Wg of the first motor MG1 is reduced by reducing the MG1 torque Tg (MG1 torque down), in step S20 corresponding to a function of the motor operation controller 56. Then, in step S30 corresponding to a function of the motor operation controller 56, the consumed electric power Wm of the second motor MG2 is controlled so that the charge/discharge electric power balance of the battery 26 does not change. When the vehicle was traveling with the charge/discharge electric power balance of the battery 26 being zero before start of the inertia phase, the second motor MG2 is controlled so as to provide the MG2 torque Tm calculated based on the above-indicated equation (1), so that the charge/discharge electric power balance of the battery 26 is kept equal to zero. Then, in step S40 corresponding to a function of the engine operation controller 55, the engine torque Te that makes the rate of change dNe/dt of the engine speed Ne equal to zero is calculated using the above-indicated equation (2), and the engine torque Te is controlled so that the engine speed Ne does not change. Then, in step S50 corresponding to a function of the shift progress determining unit 59, it is determined whether the progress of upshift of the automatic transmission 20 has reached a given degree of progress. If a negative decision (NO) is obtained in step S50, the control returns to the above-mentioned step S20. If an affirmative decision (YES) is made in step S50, the control for reducing the generated electric power Wg of the first motor MG1 is cancelled before the upshift of the automatic transmission 20 ends, in step S60 corresponding to a function of the motor operation controller 56. In accordance with this operation, the control for reducing the consumed electric power Wm of the second motor MG2 is also cancelled before the upshift of the automatic transmission 20 ends.

In FIG. 6, time t1 indicates start of upshift control of the automatic transmission 20 during traveling in the hybrid traveling mode. At time t2, the torque phase is started in accordance with generation of engaging clutch torque Tce. The clutch pressure is gradually increased from time t2, to around a predetermined inertia-phase start pressure as a clutch pressure at which the inertia phase is started (see time t3), and the engaging clutch torque Tce is increased. After time t3, the clutch pressure is gradually increased at a lower rate, and the engaging clutch torque Tce is increased. If start of the inertia phase is determined at time t4, the MG1 torque Tg (absolute value) is reduced at a given slope, and the generated electric power Wg of the first motor MG1 is reduced (see time t5). As a result, the progress of upshift of the automatic transmission 20 is accelerated. With the generated electric power Wg of the first motor MG1 thus reduced, the MG2 torque Tm is reduced and the consumed electric power Wm of the second motor MG2 is reduced, so as to keep the charge/discharge electric power balance of the battery 26 equal to zero. After time t5, the MG1 torque Tg is controlled so that the generated electric power Wg is kept reduced, and the MG2 torque Tm is controlled so that the consumed electric power Wm is kept reduced. The generated electric power Wg is kept reduced, until the progress of upshift of the automatic transmission 20 has reached the given degree of progress at time t6. After time t6, the control for reducing the generated electric power Wg of the first motor MG1 is cancelled in accordance with the shift progress, and the control for reducing the consumed electric power Wm of the second motor MG2 is also cancelled (see time t7), before time t8 at which the upshift of the automatic transmission 20 ends. During control for reducing the generated electric power Wg of the first motor MG1, the engine torque Te is changed so that the engine speed Ne does not change. The MG2 rotational speed Nm (equivalent to the AT input rotational speed Ni) during the inertia phase is determined by the engaging clutch torque Tce and the control for reducing the generated electric power Wg. However, in the shift terminal period in which the control for reducing the generated electric power Wg is cancelled, the MG2 rotational speed Nm is determined by the engaging clutch torque Tce. Therefore, when a point in time at which the control for reducing the generated electric power Wg is cancelled is earlier than that of the example of FIG. 6, the clutch torque Tce may be changed by feedback-controlling the clutch hydraulic pressure, so as to change the MG2 rotational speed Nm as desired.

As described above, according to this embodiment, the generated electric power Wg of the first motor MG1 is reduced by the given electric power from the time when it is determined that the inertia phase has started, during the inertia phase of upshift of the automatic transmission 20. Therefore, the absolute value of the MG1 torque Tg is reduced, so that the rotational speed of the transmission input shaft 34 (equivalent to the transmission member 32) reduced upon the upshift of the automatic transmission 20 is made more likely to be reduced, from the relative relationship of the rotational speeds of the three rotating elements in the power distribution mechanism 16. In addition, during the inertial phase, the consumed electric power Wm of the second motor MG2 is controlled based on the generated electric power Wg of the first motor MG1, so that the charge/discharge electric power balance of the battery 26 does not change. With the MG2 torque Tm thus reduced, the AT input rotational speed Ni is made more likely to be reduced toward the synchronous rotational speed to be achieved after the upshift. Thus, the upshift of the automatic transmission 20 is made more likely to proceed, thus making it unnecessary to increase the engaging clutch torque Tce at a higher rate during upshifting so as to shorten the shift time, and variation of the drive torque is suppressed or reduced. Thus, in the power transmission system 12 including the electric continuously variable transmission 30 and the automatic transmission 20 arranged in series, it is possible to make upshift of the automatic transmission 20 proceed quickly while suppressing variation of the drive torque.

In the control for reducing the generated electric power Wg of the first motor MG1, the consumed electric power Wm of the second motor MG2 is controlled so that the charge/discharge electric power balance of the battery 26 does not change. Therefore, even in the case where the charge/discharge electric power balance of the battery 26 is restricted, the control for reducing the generated electric power Wg can be appropriately performed.

Also, according to this embodiment, after the progress of upshift of the automatic transmission 20 reaches the given degree of progress, the control for reducing the generated electric power Wg of the first motor MG1 is cancelled by the time when the upshift ends. Therefore, the control for reducing the generated electric power Wg of the first motor MG1 is appropriately performed, during the inertia phase of upshift of the automatic transmission 20, and, after the end of the upshift of the automatic transmission 20, the vehicle travels in a condition where the MG1 torque Tg and the MG2 torque Tm are subject to no restrictions.

Also, according to this embodiment, the engine torque Te is controlled so that the engine speed Ne does not change during control for reducing the generated electric power Wg of the first motor MG1. Therefore, a variation in the engine speed Ne (or a variation in torque applied to the engine axis (e-axis)) which cannot be completely suppressed or reduced through the control of the generated electric power Wg of the first motor MG1 and the control of the consumed electric power Wm of the second motor MG2 can be suppressed. While there is a possibility that the engine torque Te changes during this control, the control aims to absorb a variation in engine torque which cannot be completely suppressed through the control of the first motor MG1 and the second motor MG2. Accordingly, the variation in the engine torque Te is sufficiently small, as compared with control, like the above-described engine torque correction control, for positively changing the engine torque Te. In the upshift of the automatic transmission 20 while keeping the engine speed Ne constant, the engine speed Ne is less likely or unlikely to change during control. If the engine operating point lies on the engine optimum fuel efficiency point before control, the operating point can be kept at the engine optimum fuel efficiency point.

Also, according to this embodiment, the shift time of upshift of the automatic transmission 20 can be shortened, by increasing the given electric power by which the generated electric power Wg of the first motor MG1 is reduced, without increasing the engaging clutch torque Tce at a higher rate during upshifting. Accordingly, variation in the drive torque is suppressed even if the shift time is shortened.

While one embodiment of the disclosure has been described in detail with reference to the drawings, this disclosure may be applied in other forms.

For example, in the above-described embodiment, the automatic transmission 20 in the form of the planetary gear type automatic transmission is illustrated by way of example as the mechanical speed change mechanism that provides a part of the power transmission path between the transmission member 32 and the drive wheels 18, but the mechanical speed change mechanism is not limited to this type of transmission. For example, the mechanical speed change mechanism may be a known synchromesh parallel two-axis type transmission including a plurality of pairs of shift gears that constantly mesh with each other between two axes. More specifically, the mechanical speed change mechanism may be a synchromesh parallel two-axis type automatic transmission as one type of synchromesh parallel two-axis type transmission, in which engagement and release of dog clutches (i.e., mesh-type clutches) are controlled by actuators, so that the gear position is automatically changed, or a known DCT (Dual Clutch Transmission) as one type of synchromesh parallel two-axis type automatic transmission, which has input shafts on two systems or lines.

In the above-describe embodiment, after the inertia phase is started, the generated electric power Wg of the first motor MG1 is kept reduced by the given electric power, until the progress of upshift of the automatic transmission 20 reaches a given degree of progress. However, the disclosure is not limited to this arrangement. After the generated electric power Wg is reduced by a given electric power, it is not necessarily kept in the reduced state, but the generated electric power Wg may be further reduced, or the generated electric power Wg may be increased.

It is to be understood that the above-described embodiment is a mere example, and that this disclosure may be embodied with various changes or improvements, based on the knowledge of those skilled in the art.

What is claimed is:

1. A control system for a power transmission system,
the power transmission system including
an engine,
a first motor for differential operation,
a second motor for traveling of a vehicle,
an electric speed change mechanism including a differential mechanism, the differential mechanism including three rotating elements, the three rotating elements including an input element, a reaction-force element, and an output element, an operating state of the first motor being controlled such that a differentially operating state of the differential mechanism is controlled, the output element couples to the electric speed change mechanism,
the input element being coupled to the engine such that power of the engine is transmitted to the input element,
the reaction-force element being coupled to the first motor such that power of the first motor is transmitted to the reaction-force element,
the output element being coupled to the second motor such that power of the second motor is transmitted to the output element,
a mechanical speed change mechanism that provides a part of a power transmission path between an output rotating member of the electric speed change mechanism and drive wheels, the mechanical speed change mechanism being adapted to be shifted into a selected one of a plurality of gear positions, through engagement and release of at least one engagement device, and
a power storage device that supplies and receives electric power to and from each of the first motor and the second motor,
the control system comprising
an electronic control unit configured to:
determine whether an inertia phase has started, during an upshift of the mechanical speed change mechanism;
reduce generated electric power of the first motor by a given electric power, from a point in time at which the electronic control unit determines that the inertia phase has started; and
control consumed electric power of the second motor based on the generated electric power of the first motor, such that charge and discharge electric power balance of the power storage device remains constant.

2. The control system according to claim 1, wherein
the electronic control unit is configured to:
determine whether a progress of upshift of the mechanical speed change mechanism has reached a given degree of progress; and
inhibit control for reducing the generated electric power of the first motor before the upshift ends, when the electronic control unit determines that the progress of the upshift has reached the given degree of progress.

3. The control system according to claim 1, wherein
the electronic control unit is configured to
control engine torque such that a rotational speed of the engine remains constant, during control performed by the electronic control unit for reducing the generated electric power of the first motor.

4. The control system according to claim 1, wherein
the electronic control unit is configured to
increase the given electric power by which the generated electric power of the first motor is reduced, as a target shift time of upshift of the mechanical speed change mechanism is shorter.
